(19) United States
(12) Patent Application Publication
(10) Pub. No.: US 2006/0117963 A1
(43) Pub. Date: Jun. 8, 2006

(54) Food shaping utensil

(76) Inventors: Doug Paul Schneider, Seattle, WA (US); Benjamin Soltero Ramos, Arlington, WA (US)

Correspondence Address: DOUG SCHNEIDER, 2318 2ND AVE., STE. 342-A, SEATTLE, WA, 98121-1780, US

(21) Appl. No.: 11/003,879

(22) Filed: Dec. 2, 2004

(51) Int. Cl. A47J 37/12

(52) U.S. Cl. 99/403

(57) ABSTRACT

A utensil for preparing filled food items, such as tacos, pastries or dumplings, is disclosed, having a pair of engaging clamping molds, pivotally connected by a hinge assembly. Each clamping mold has a preconfigured form in the shape of the desired resulting, food item, generally comprising a hollow, concave center and a flattened perimeter. Together, the two clamping molds and the attached hinge assembly form a clamping assembly. The clamping assembly is in the open position when the perimeters of the opposing clamping surfaces are disengaged and in the same plane. In this position, a flat bread or tortilla is placed on the surfaces and a filling is laid on top. The clamping assembly is in the closed position when the perimeters of the opposing clamping surfaces are engaged. When the clamping assembly is closed the perimeter edges of the tortilla are sandwiched between the clamping surfaces and the filling is enclosed within. A rectangular rack having a plurality of symmetrically positioned slots provides the means for locking the clamping assembly in the closed position. The lower part of the clamping assembly is inserted into two opposing slots, preventing the clamping molds from disengaging. A plurality of clamping assemblies can be mounted into the remaining pairs of slots. A handle is provided on one end of the rack to allow the cook to submerge the rack into a deep-fryer. A hook at the other end of the rack is provided to suspend the rack over the deep-fryer, allowing excess oil to drip back into the deep-fryer.

### CROSS REFERENCE TO RELATED APPLICATIONS

Not Applicable

### FEDERALLY SPONSERED RESEARCH

Not Applicable

### SEQUENCE LISTING OR PROGRAM

Not Applicable

### BACKGROUND OF THE INVENTION

1. Field of the Invention

The present invention relates to preparing filled foods and, more particularly, to pre-filled foods that are deep-fried.

2. Prior Art

The idea of deep-frying filled pastries or filled tacos is not new. The problem is how to make them quickly and efficiently in a restaurant or food service setting and to make them look attractive to the consumer, without spending additional time in the process.

Some dough-based pastries can be filled and folded rather easily and they will remain closed due to the properties of gluten contained in dough made of wheat, but other flours, made from grains such as corn and rice, do not have the sticky property of gluten and cannot hold complex shapes as easily. Cooked flatbreads, made from any flour, do not have the stickiness required to maintain a seal at the outer edges when filled and folded. Additionally, the process of filling and deep-frying, larger food items, regardless of the flour used, is time-consuming and cumbersome because the weight of the filling distorts the outer shell if no additional support is offered. Furthermore, the restaurant environment demands adherence to exceptionally sanitary conditions. Any food service appliance or utensil must be easily cleaned and not allowed to harbor particles of food. The attractiveness of the food is also paramount. A consistent, decorative product will sell much better than one that is roughly made or sloppy.

U.S. Pat. No. 5,937,743 issued in the name of Overstreet discloses a cooking device for deep-frying meat filled tacos. U.S. Pat. No. 5,937,743 does not address various problems associated with food preparation in the food industry. Efficiency, sanitation, presentation and effectiveness are four such problems. In U.S. Pat. No. 5,937,743, preparing a filled taco as described in this solution, requires pinching the spring-based clamp with one hand, while holding a pre-filled taco in the other hand. This is cumbersome for a cook in a busy kitchen. After deep-frying, the spring-based clamp is hot and cannot be touched with a bare hand for several minutes. The spring-based clamp also presents another problem: the coil is likely to accumulate food debris from the deep-fry oil. Also, this solution does not address presentation and consistency. Each food item is filled, folded and inserted into the mold, but the mold itself does not attribute to the shape or configuration of the final product, other than to hold it in the folded position in which it was originally placed. Most importantly, this solution does not actually contain the taco or its filling, in an enclosure. The top of the cooking device is left open while only the bottom portion of each mold engages the other mold. The taco itself is not closed so that the meat may actually float out as the taco is lowered into the deep-fry oil. This would make the invention less effective and contribute to the problem of sanitation as the oil accumulates debris.

### OBJECTS AND ADVANTAGES

It is therefore an object of the invention to allow a person to fold a tortilla or other pliable flat bread, place a filling of choice inside the fold, seal the edges and prevent the pliable bread from opening or spilling its contents during the cooking process.

It is another object of the invention to cook a filled and folded flatbread or tortilla to create a food that maintains its filled and folded shape, after cooking.

It is another object of the invention to transfer decorative shapes, patterns, words, letters, logos or symbols from the invention onto the outer shell of the cooked food.

It is another object of the invention to provide a device for the above mentioned purposes, which will not accumulate food debris in crevices and can easily be cleaned. The importance of this pertains to the use of the invention in restaurants and other food service businesses, where sanitary conditions and health department regulations are paramount.

### SUMMARY

In accordance with the present invention there is provided, a food shaping device having a pair of cooperating, engaging, clamping molds which compress together the outer edges of a folded food item, a fastening arrangement which secures the clamping molds in a closed position and a method for supporting the assembled clamping molds throughout a cooking process.

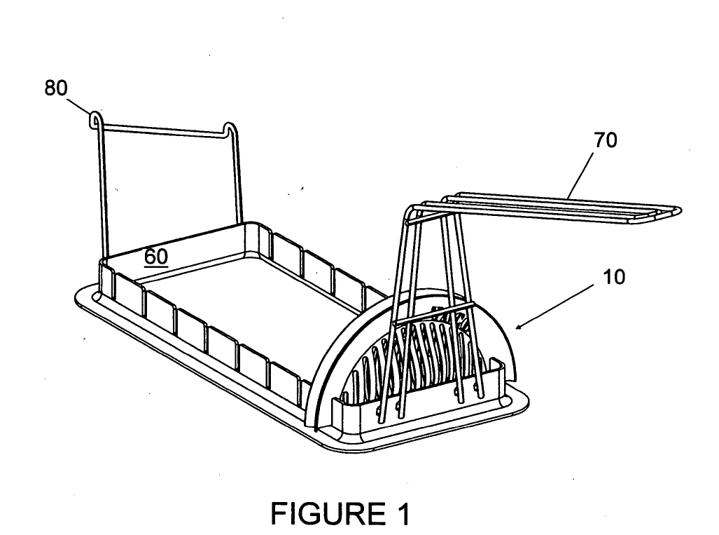

FIG. 1 is a perspective top view the preferred embodiment of the food shaping utensil in accordance with the invention.

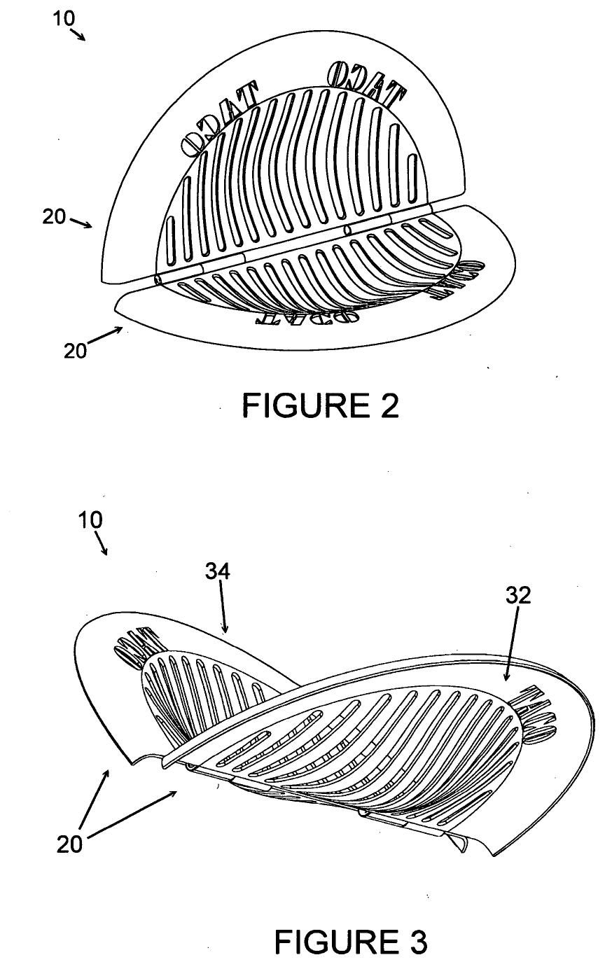

FIG. 2 is a perspective top view of the preferred embodiment of the clamping assembly, in a partially open position.

FIG. 3 is bottom perspective view of a preferred embodiment of the clamping assembly, in a partially open position, angled to show interior and exterior.

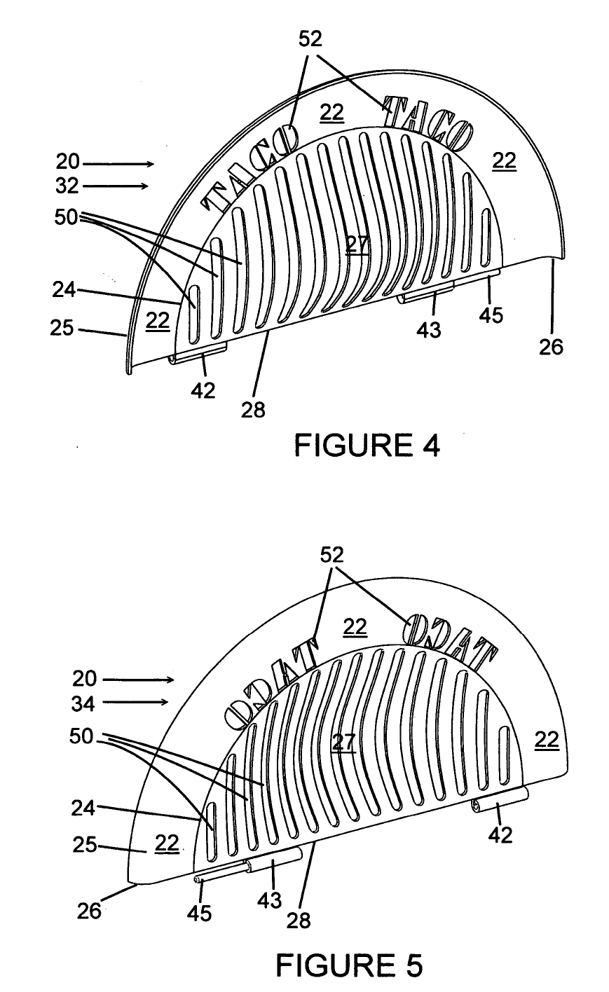

FIG. 4 is a perspective view of an exterior side of a clamping mold in the vertical position.

FIG. 5 is a perspective view of an interior side of a clamping mold in the vertical position.

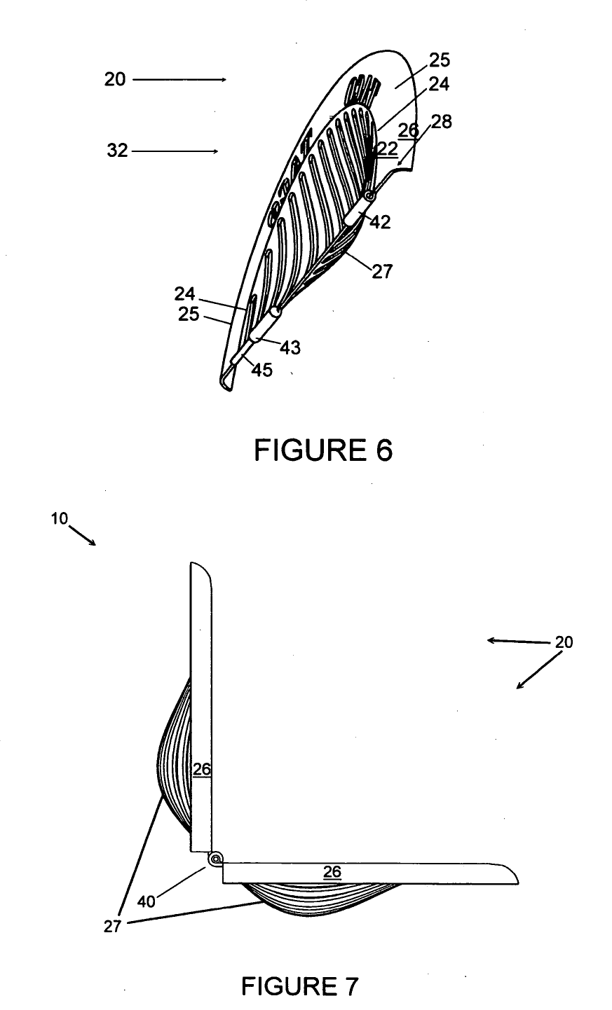

FIG. 6 is a bottom perspective view of a clamping assembly, illustrating the placement of the first hinge section and the second hinge section with respect to the clamping surface.

FIG. 7 is a side view of a clamping assembly.

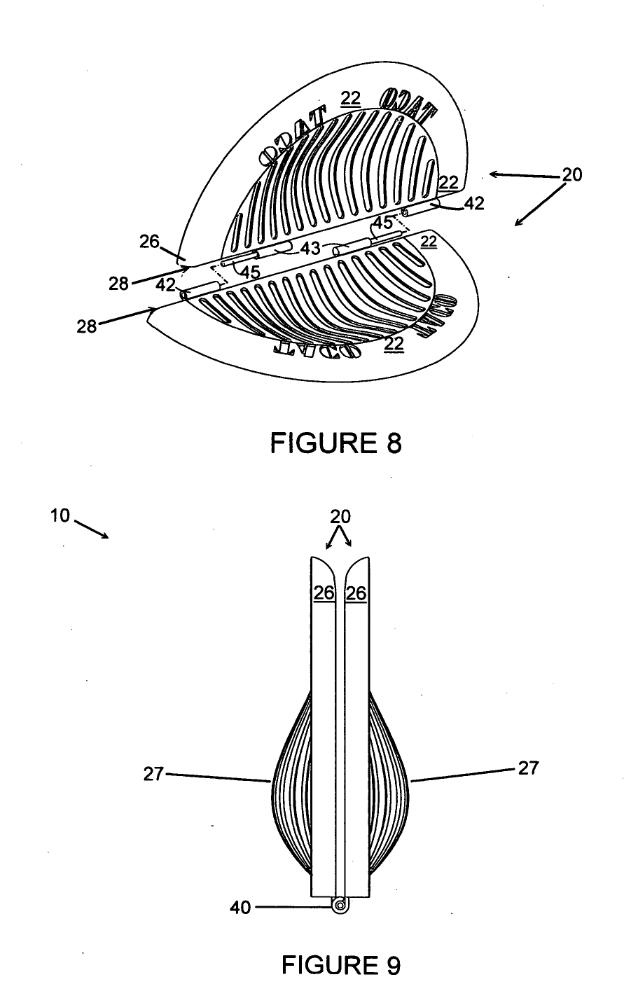

FIG. 8 is an exploded perspective view of a preferred embodiment of the clamping assembly.

FIG. 9 is a side view of a clamping assembly in the vertical and closed position.

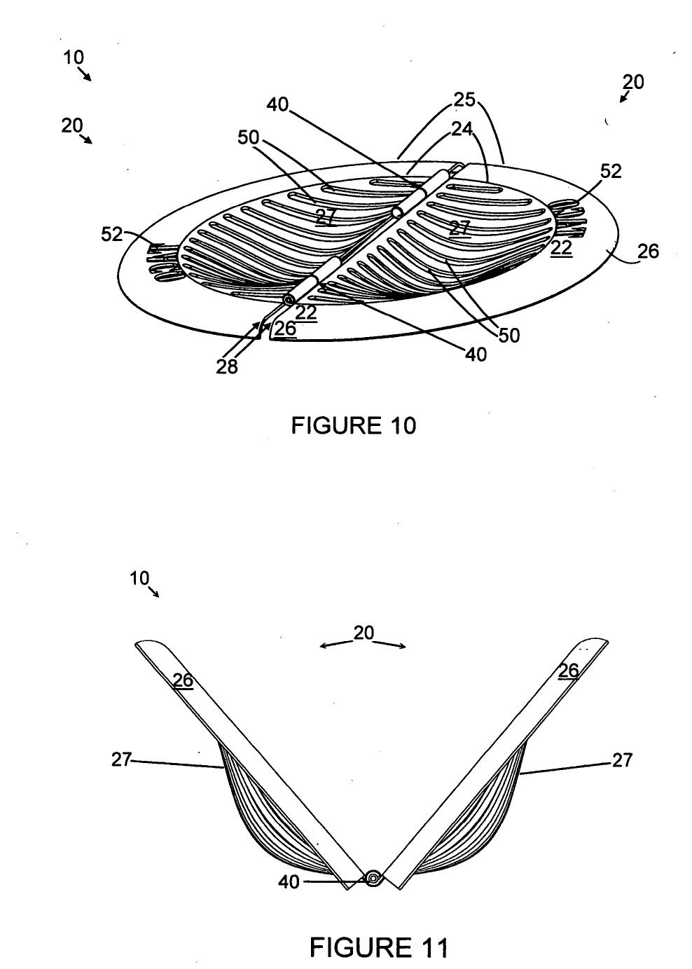

FIG. 10 is a perspective view of a clamping assembly in the lateral and open position.

FIG. 11 is a side view of a clamping assembly in the vertical and partially opened position.

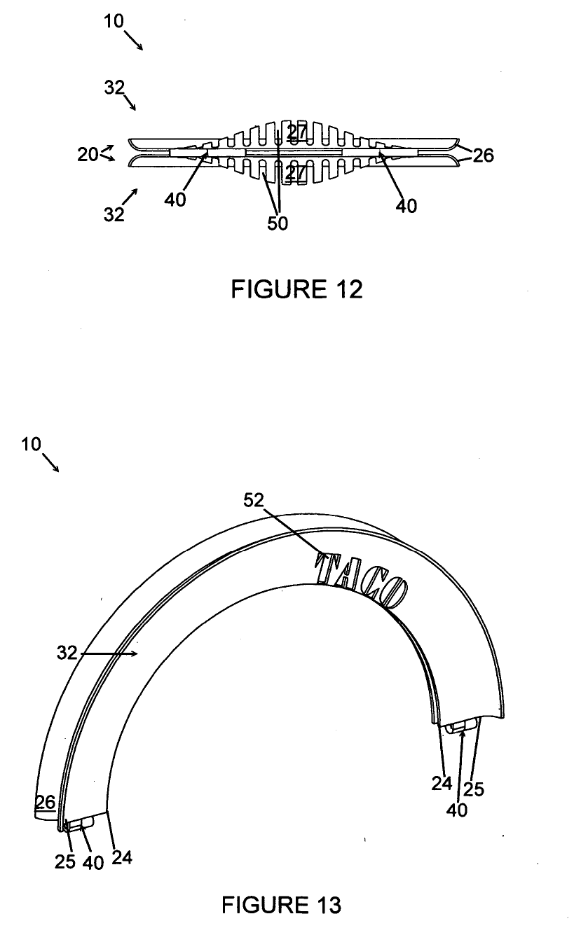

FIG. 12 is a bottom view of a clamping assembly in the closed position.

FIG. 13 is a perspective view of a clamping assembly with the concaved sections omitted.

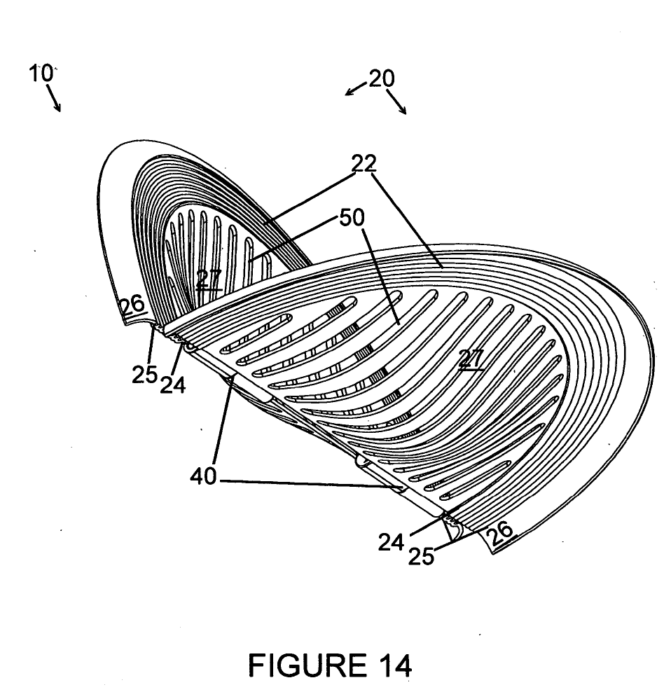

FIG. 14 is a perspective view of an open clamping assembly with a grooved surface.

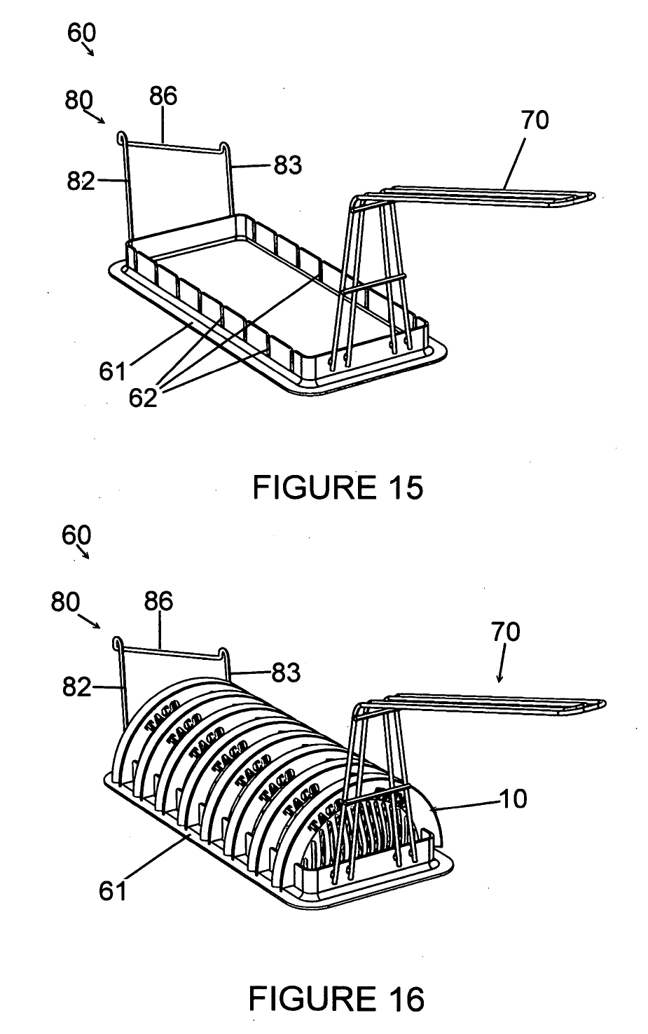

FIG. 15 shows an empty rack, with no clamping assemblies mounted.

FIG. 16 is a perspective view of a rack with a plurality of clamp assemblies mounted on the rack.

### DRAWING LIST OF REFERENCE NUMBERS

10 Clamping Assembly
20 Clamping Mold
22 Clamping surface
24 Inner Border
25 Outer Perimeter
26 Flanged Rim
27 Concaved Section
28 Diameter Section
32 Front side
34 Back side
40 Hinge Assembly
42 First Hinge Section
43 Second Hinge Section
45 Hinge Pin
50 Apertures
52 Aperture patterns
60 Rack
61 Base
62 Slots
70 Handle
80 Hook
82 Long Leg
83 Short Leg
86 Lateral Wire

### Description of the Preferred Embodiment

According to a first aspect of the preferred embodiment of the invention, there is provided a clamping assembly 10 illustrated in FIG. 2, including two identical clamping molds 20 formed from sheet metal. FIG. 3 shows a different angle so that both a front side 32 and a back side 34 of the clamping mold are shown.

FIGS. 4 and 5 are perspective views of the front side 32 and back side 34 respectively, of the preferred embodiment of one clamping mold 20 positioned vertically. The clamping mold 20 has a semi-circular shape comprising a semi-circular outer perimeter 25 and a flat diameter section 28. The semi-circular outer perimeter 25 is bordered by a flanged rim 26 which is rolled towards the front side 32 of the clamping mold 20. Concentric to the outer perimeter 25, is positioned a semi-circular inner border 24, with a shorter radius than the outer perimeter 25. Together, the semi-circular outer perimeter 25 and the semi-circular inner border 24 define two sides of the clamping surface 22. The clamping surface is a relatively flat, semi-circular, arc shape which is terminated at both ends by the end portions of the diameter section 28.

A semi-circular concaved section 27 is positioned contiguously to the clamping surface 22. The concaved section 27 is bounded by the center portion of the diameter section 28 and by the semi-circular inner border 24. The concaved section 27 extrudes toward the front side 32 and has a plurality of apertures 50.

In this preferred embodiment, the clamping surface 22 has a plurality of aperture patterns 52. The aperture patterns are 52 configured to form letters, words or other designs whereby said designs are transferred onto the enclosed food during the cooking process.

FIG. 6, a bottom perspective view of the clamping assembly, illustrates a first hinge section 42 and a second hinge section 43. The first and second hinge sections 42 and 43 are thin cylinders with a hollow core. Each cylinder is rolled from tabs extruded from the same sheet metal which forms the clamping mold 20. The tabs are positioned on the diameter section 28 and rolled forward, toward the front side 32 to form thin, hollow cylinders.

Additionally, the second hinge section 43 has a rigidly attached, solid metal hinge pin 45 protruding from the end of the hollow core. The length of the hinge pin 45 is twice the length of the cylinder and is inserted completely through the core such that one end of the hinge pin 45 is flush with one end of the cylinder and the other end of the hinge pin 45 protrudes from the other end of the cylinder. The hinge pin 45 is of sufficiently small diameter to fit snugly into the diameter of the hollow core of the second hinge section 43, without sliding out. The first hinge section 42 has a diameter slightly larger to allow a snug fit, but also allows the hinge pin 45 to slide in and out laterally.

The first hinge section 42 is positioned laterally on the diameter section 28 such that one end aligns with an intersection of the diameter section 28 and the inner border 24 while the other end points toward the center of the diameter section 28.

The second hinge section 43 is placed laterally on the diameter section such that the end of the hinge pin 45 aligns with the opposite intersection between the diameter section 28 and the inner border 24 and the cylinder is further toward the center of the diameter section 28.

FIG. 7 illustrates the position of the hinge assemblies, from a side view.

FIG. 8 shows an exploded view of the clamping assembly 10, illustrating the sequence for joining two clamping molds 20 to form a clamping assembly 10. Two clamping molds 20 are adjacently arranged about their diameter sections 28. The molds 20 are pivotally and removably connected by sliding the hinge pin 45 of the second hinge section 43 into the cylinder of the first hinge section 42, forming an axis of rotation about a hinge assembly 40. The closed, open and partially open positions are respectively illustrated in FIGS. 9, 10 and 11. A bottom view of the closed clamp assembly is shown in FIG. 12. More than one hinge assembly may be used as long as they are linearly positioned to form a single axis of rotation.

In this preferred embodiment as illustrated in FIG. 1, a rack 60 and a plurality of slots 62 on the rack, provide means for locking the clamping assembly 10 into the closed position. FIG. 15 shows the empty rack 60, with no clamping assemblies 10 mounted. The rack 60 comprises an elongated length of sheet metal formed into a rectangular shape, with vertical sides. The width of the rack 60 is slightly wider than the diameter of the semi-circular, inner border 24 of a clamping mold 20. The length of the rack 60 may be any length appropriate for fitting into a conventional deep fryer.

A base 61 on the rack 60 is formed by an outwardly rolled flange at the bottom perimeter of the rack 60.

Along the longitude of the rack 60 are evenly spaced, vertical slots 62. Each slot 62 is positioned symmetrically to a slot 62 on the opposite side of the rack 60. The slots 62 are only slightly wider than the thickness of the two clamping surfaces 22 combined. As shown in FIG. 1, a closed clamping assembly 10 containing a folded flatbread, sandwiched between the clamping surfaces 22, may be removably mounted, vertically into two opposing slots 62. The narrow widths of the slots 62 urge the bottom portion of the clamping surfaces 22 toward each other whereby the clamping assembly 10 is locked into the closed position. Additionally, the flanged rim 26 and the position of the hinge assemblies 40, block lateral movement of the clamping assembly 10 within the slots 62.

Also illustrated in FIG. 15 is the preferred embodiment of a rack handle 70, which provides means for supporting and manipulating said clamping assembly 10 during deep-frying or other cooking process, without direct contact by bare hands.

The rack handle 70 may be made of two rigid wires, each bent into the shape of an elongated A-frame, one A-frame being slightly smaller than the other. The smaller A-frame shape is nested inside the boundaries of the larger A-frame. The bases of the A-frames are rigidly fixed to one end of the rack 60. The top half of the A-frames are bent away from the rack 60 at approximately ninety-degrees to the bottom half of the A-frame. A lateral cross-member is secured to the nested A-frames at the points where the frames are bent and another lateral cross-member is secured to the A-frames, halfway between the bend and the base of the A-frame.

FIG. 15 further shows a hook 80 which provides means for suspending the clamping assembly 10 above hot cooking liquid or hot oil, such that liquid accumulated in the clamping assembly 10 from a preceding submersion, seeps back into the cooking liquid.

The hook 80 may be made from rigid wire and is formed by two parallel, vertical metal legs 82, 83 of different lengths, rigidly fixed at opposing corners on the end of the rack 60, opposite from the rack handle 70. Each vertical wire is arched forward, away from the rack, to form substantially parallel J-shaped hooks. The ends of the hooks are interconnected by a lateral wire 86, slanted to accommodate the differing lengths of the vertical legs 82, 83. The adjoined “J” shapes form an angled hook 71, such that, when the rack 60 is suspended from this hook 71, it is suspended at a tilt, encouraging liquid accumulated in the clamping assembly from a preceding submersion, to seep back into the cooking liquid.

A preferred embodiment of food shaping utensil in the present invention, as shown in FIG. 1, includes the clamping assembly 10, the rack 60, the handle 70 and the hook 71, as main components. The clamping assembly 10 is removably mounted on the rack 60. The handle 70 and hook 71 are rigidly fixed to the rack 60. In this preferred embodiment, the rack has a plurality of slots 62, such that a plurality of clamping assemblies 10 can be placed in the rack 60 as shown in FIG. 16, and heated simultaneously.

### Operation of the Preferred Embodiment

An advantage of the invention in its preferred embodiment is its ease of use, particularly in a restaurant kitchen environment, where efficient use of time is important.

The clamping assembly 10 may be placed on a flat surface, in the open position as in FIG. 10 or in a partially open position as in FIG. 11 or it may be held in an open or cupped hand. The tortilla or other flatbread is laid on top, such that the perimeter of the tortilla is concentric with the outer perimeter 25 of the clamping assembly 10. The filling ingredient is placed on top of the tortilla, preferably above the diameter sections 28 of the clamping molds 20. The two clamping molds 20 are pivoted about an axis toward each other until engaged with the edges of the tortilla sandwiched between the clamping surfaces 22. The clamping surfaces 22 are urged together between the thumb and forefinger until is the clamping assembly is mounted vertically in the rack 60 by sliding the lower portion of the clamping assembly into two opposing slots 62. This process may be repeated a number of times with additional clamping assemblies 10 until all the slots 62 are filled.

The rack 60 is lifted by the handle 70 and subsequently submerged in a container of hot oil or other hot liquid such that the top portion of the handle 70 remains above the surface of the liquid but the rack 60 and mounted clamping assemblies 10 are submerged. Oil or hot liquid enters the clamping assemblies 10 through the apertures 50 and begins the cooking process. After allowing sufficient time for the cooking process to complete, the handle 70 is grasped and the rack 60 and clamping assemblies 10 are lifted above the surface of the liquid. The rack hook 71 is engaged to the back rim of the hot oil container such that the rack 60 is tilted laterally and remains suspended above the surface of the hot liquid. Excess fluid seeps from the clamp assembly and the enclosed food and drips back into the hot oil container. When the rack hook 71 is disengaged and the rack 60 is removed from the frying container, the clamp assemblies 10 are removed and opened. Revealed inside, is a sealed food item with a filling. Aperture patterns 52, in the clamping surfaces 22 partially expose the taco edges to hot oil, liquid or air, producing a branding effect and reproducing the patterns on the food surface. Apertures patterns 52 forming letters, words and logos reproduce these patterns on each food item and lend themselves to further marketing the restaurant in which they were made.

Cleaning the invention is very simple because there are no small areas to accumulate debris. The hinges sections disengage, freeing the two molds so and allowing the hinge parts to be easily cleaned.

In a different embodiment, the aperture patterns 52 are omitted and the resulting food item has an unembellished edge.

In other variations, the shape of the clamping mold 20 can be configured to any predetermined shape or size desired that accommodates a filled and folded food item such that two clamping surfaces 22 compress the opened edges of the outer food wrap.

A further variation is to use any of the above embodiments in such a way that no portion of food is compressed, but instead, the food is entirely contained inside the concaved section 27. The merits of this method would be to use the invention simply to deep-fry any item whose shape does not conform to the clamping mold.

FIG. 13 shows another embodiment in which the concaved section 27 has been omitted. The hinge assemblies 40 are necessarily repositioned laterally in opposite directions, toward the edges of the diameter section 28. The clamping surface 20 still compresses the opening of the tortilla, but allows for more filling to expand the center of the food item if desired.

In other embodiments, not shown, the hinge assemblies or assembly 40 could be positioned at a point elsewhere on the perimeter 25 of the clamping molds 20, forming an axis of rotation at a point not on the diameter section 28. Or, the hinges 40 may be omitted completely, such that the clamping assemblies 10 are manually engaged and locked into the engaged position when mounted on the rack.

In still another embodiment, the flanged rim 26 could be omitted.

In further embodiments as illustrated in FIG. 14, variations in the clamping surface 22 may be applied including, a textured, scalloped or embellished clamping surface 22 or, the surface 22 may be crimped, grooved or pressed into any form that can engage an opposing clamping surface 22 of a similar form.

In additional embodiments, the means for locking the clamping molds 20 in a releasable engaged position whereby sufficient urging is applied to keep the clamping molds 20 engaged can include clips, magnets, wires, pins or other locking mechanism. In further embodiments, the means for supporting and manipulating the clamping assembly 10 whereby said clamping assembly 10 can be submersed in and retrieved from a heated cooking environment, without being directly contacted by bare hands, includes heat-resistant silicon gloves, baskets, tongs, oven mitts, pliers or any of a variety of traditional and non-traditional means for manipulating hot cooking utensils.

The invention can be made of metals, ceramics, silicone or other stiff, heat resistant, food grade materials alone or in combination.

### Advantages

From the description above, a number of advantages of our food shaping utensil become evident:
(a) The invention easily and efficiently prepares a completely closed, filled food item.
(b) The invention is the only product that can produce such a food item from flours such as corn and rice. Corn and rice flours contain no gluten as a binder consequently they cannot easily be deep-fried without egress of their contents.
(c) The invention allows the food item to be quickly and easily decorated, branded with a logo or otherwise embellished, thereby producing a more appealing product for the consumer.
(d) The invention is useful in a restaurant environment where quick preparation and attractive results are required.
(e) The invention can be used in a deep-fryer, in hot soup or placed in an oven for varying results.
(f) The invention can be used to make various foods such as tacos, empanadas, dumplings or hand pies.

Conclusion, Ramifications, Scope

Accordingly the reader will see that the food shaping utensil of this invention can be used to prepare filled food items using a variety of ingredients. Handheld food items, such as tacos, hand pies and pita pockets have always been popular. Previously, the problem of keeping the filling inside the wrapping had impeded the making of deep-fried, filled food items. The food shaping utensil makes the preparation of deep-fried handheld foods a quick, 5-step process:
1) Layer the ingredients on the front side of an open clamping assembly, beginning with the outer wrapping and finishing with the filling.
2) Close the clamshell clamping assembly.
3) Insert the assembly into the rack slots.
4) Grasp the handle and lower the rack into the fryer.
5) Allow time for cooking, then lift the rack out of the flyer and hang by the hook on the side of the fry oil container.

The same process can be followed for cooking processes other than deep frying, with the exception step 4. Instead of placing the rack into a deep-fryer, it is placed into hot liquid, an oven or other heating element.

By purchasing the food shaping utensil in a variety of shapes, the restaurateur can deep-fry, poach or bake, handheld foods in a variety of shapes and textures. Just as importantly, it takes no special skill or an excessive amount of time to prepare these foods.

The food shaping utensil has another value in the food preparation process: embellishments on the clamping surfaces are imprinted on the edges of the finished food products, adding appeal to the food. A clamping surface with apertures in the form of a logo or brand name, can add the restaurant's name to the surface of the finished food product, adding value in the form of advertising to take-out food.

With the advent of new, hi-tech deep-flyers, deep-fried food has become increasingly popular in bars and small restaurant kitchens that previously had no space or personnel for a deep-fryer. The food shaping utensil is a timely addition to this trend, increasing the possibilities for variety in quickly made, deep-fried foods.

Although the description above contains many specificities these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A food shaping utensil comprising: a clamping assembly including a pair of cooperating and engaging, first and second clamping molds;
first means for locking said first and second clamping molds in a releasable engaged position whereby sufficient urging is applied to keep the clamping molds in contact with each other;
second means for supporting and manipulating said clamping assembly whereby said clamping assembly can be submersed in hot cooking liquid, hot oil or placed in a hot oven without being directly contacted by bare hands.

2. A food shaping utensil as in claim 1, wherein each said clamping mold has a clamping surface and a predetermined shape with an outer perimeter.

3. A food shaping utensil as in claim 2, wherein said clamping surface has an inner border within the boundaries of the outer perimeter.

4. A food shaping utensil as in claim 2, wherein said inner border has a predetermined curvature substantially paralleling the perimeter edge of the opening of a folded tortilla, pastry or any other such filled food items, whereby said perimeter edge of the desired food item, may be sandwiched between the clamping surfaces and slightly compressed when the clamping molds are engaged.

5. A food shaping utensil as in claim 2, wherein said clamping molds have apertures patterned in the form of letters, symbols, designs, trademarks or any other such patterns, whereby said apertures will reproduce said patterns, on the food beneath said aperture when said food is sandwiched between the clamping molds and subjected to baking, deep-frying or other cooking.

6. A food shaping utensil as in claim 1, further including a hinge assembly or assemblies wherein said clamping molds are arranged adjacently and symmetrically about an axis, said hinge assembly is positioned at said axis and secured at corresponding points on the outer perimeters of each clamping mold and whereby the hinge or hinges are between the first and second clamping molds when the assembly is in the open position;

7. A food shaping utensil as in claim 2, wherein said clamping surfaces are smooth and unembellished.

8. A food shaping utensil as in claim 2, wherein said clamping surfaces are scalloped, fluted, etched, grooved, dimpled, stenciled, embellished or textured.

9. A food shaping utensil as in claim 2, wherein the clamping surfaces are flat.

10. A food shaping utensil as in claim 2, wherein the clamping surfaces are rounded, indented, sloped, tilted, curved, rippled or any other shapes which allows the opposing clamping molds to engage.

11. A food shaping utensil as in claim 2, wherein the clamping assembly further includes two, substantially symmetrical, concaved sections each positioned contiguously at said inner borders whereby the concaved sections form a closed concavity when the utensil is in the closed position.

12. A food shaping utensil as in claim 11, wherein said concaved sections have a plurality of apertures whereby hot oil or heat is allowed to enter and to cook the encased food item.

13. A food shaping utensil as in claim 1, further including means for suspending the clamping assembly above hot cooking liquid or hot oil, such that liquid accumulated in the clamping assembly from a preceding submersion, seeps back into the cooking liquid.

14. A food shaping utensil as in claim 1, wherein said outer perimeters include flanged rims flaring outward in opposing directions, whereby said rims form gripping points which facilitate prying the two clamping molds apart.

15. A food shaping utensil as in claim 6, wherein each said hinge assembly comprises a first and second hinge sections.

16. A hinge assembly as in claim 15, wherein the first hinge section is rigidly attached to the first clamping mold, the second hinge section is rigidly attached to the second clamping mold and the first and second hinge sections are removably attached to each other.
